(19) United States
(12) Patent Application Publication
(10) Pub. No.: US 2007/0240149 A1
(43) Pub. Date: Oct. 11, 2007

(54) System and method for device driver updates in hypervisor-operated computer system

(75) Inventors: Daryl Carvis Cromer, Cary, NC (US); Scott Edwards Kelso, Durham, NC (US); Howard Jeffrey Locker, Cary, NC (US); John Carl Mese, Cary, NC (US); Nathan J. Peterson, Raleigh, NC (US); Randall Scott Springfield, Chapel Hill, NC (US); Rod David Waltermann, Rougemont, NC (US); Arnold S. Weksler, Raleigh, NC (US)

Correspondence Address: ROGITZ & ASSOCIATES, 750 B STREET, SUITE 3120, SAN DIEGO, CA, 92101, US

(73) Assignee: Lenovo (Singapore) Pte. Ltd.

(21) Appl. No.: 11/394,276

(22) Filed: Mar. 29, 2006

(51) Int. Cl. G06F 9/44

(52) U.S. Cl. 717/171

(57) ABSTRACT

A hypervisor-based system and method for downloading device driver updates that prevents confusion on the part of the driver update software as to which driver, physical or virtual, is being updated.

### I. FIELD OF THE INVENTION

The present invention relates generally to updating device drivers in hypervisor-based computer systems.

### II. BACKGROUND OF THE INVENTION

Hypervisors are computer programs that allow different operating systems to run on the same hardware concurrently. This has many advantages, including resource isolation and the ability to concurrently run different operating systems and associated applications.

In a so-called “type 1” hypervisor, the hypervisor executes directly on the hardware, with the user operating systems running on top of the hypervisor and essentially controlling “virtualized” versions of devices (such as hard disk drives) within the hypervisor. Type-1 hypervisors allow good performance in each operating system as compared to so-called “type 2” hypervisors that execute on top of an existing operating system, i.e., a type-2 hypervisor is separated from the hardware by an existing operating system. As understood herein, type 1 hypervisors are ideally suited for client manageability, because, e.g., the first operating system may be a User Operating System (U.O.S.) such as Microsoft XP while the second operating system can be a Service Operating System (S.O.S.) such as Linux or Microsoft Windows PE that can be used for client manageability purposes.

As understood herein, to maximize the client manageability benefits in this environment, devices such as hard disk drives can be “virtualized”, meaning that, for protection, the devices can be accessed by the U.O.S. only through the hypervisor. In other words, the U.O.S. accesses a “virtual” device in the hypervisor, with the hypervisor allowing the S.O.S. to manage the underlying physical device.

The present invention recognizes that it is often desired to update the physical device driver in the S.O.S. and/or the virtual device driver in the U.O.S. As understood herein, however, “virtualization” introduces challenges to updating device driver software because the driver is “virtualized” from the physical device and is hidden from the U.O.S.

With greater specificity, ordinarily driver updates are based upon a so-called plug-and-play (PnP) identification, which is composed of four subsidiary identifications. As critically recognized herein, if the physical device has the same PnP ID as the virtual device, should a user attempt to update his system, the device driver update software will not be able to decide which driver to update, because it will be unable to distinguish the physical device from the virtual device. Accordingly, as understood herein, because the U.O.S. sees only the “virtualized” device with accompanying identifications, and because the hypervisor that manages the physical device does not have automatic device update capability, updates to device drivers cannot be obtained in the above-mentioned environment.

### SUMMARY OF THE INVENTION

A method is disclosed for updating a device driver in a computer that implements a hypervisor which in turn instantiates a virtual device replication of a physical device. The method includes deriving a virtual ID from a corresponding physical ID associated with the physical device, and providing the virtual ID and physical ID to an update provider. Using the virtual ID and physical ID, it is determined which of a physical device driver and a corresponding virtual device driver corresponds to a driver update.

In one non-limiting implementation the physical and virtual IDs are physical and virtual plug-n-play (PnP) IDs, respectively, with each having respective sub-IDs. One or more of the sub-IDs of the physical PnP ID can be mapped from their original values to virtual sub-ID values during instantiation of the virtual device, and the virtual ID and physical ID can be cross-correlated. In a specific non-limiting implementation, the virtual PnP ID has the same subsystem vendor ID and subsystem ID as the physical PnP ID, with the vendor ID and/or device ID of the virtual PnP ID being different than the respective vendor ID/device ID of the physical PnP ID. In another implementation, the physical PnP ID is the same as the virtual PnP ID with the exception of a value of at least one bit in the device ID representing whether the associated device is physical or virtual.

In another aspect, a computer system has a processor executing a hypervisor and a service operating system (S.O.S.) operating on the hypervisor. Also, a user operating system (U.O.S.) operates on the hypervisor. A physical device with associated physical device driver is controlled by the S.O.S., while a hypervisor-instantiated virtual device representing the physical device and being associated with a virtual device driver is controlled by the U.O.S. Means are provided for downloading device driver updates that prevents confusion on the part of driver update software as to which driver, physical or virtual, is being updated.

In one implementation, the means for downloading includes the processor executing logic which includes causing the S.O.S. to divulge to the U.O.S. a PnP ID associated with the physical device, detecting the nature of the device against which a driver update is being installed, real or virtual, and installing a driver update accordingly. In another implementation, the means for downloading includes the processor executing logic including deriving a virtual ID from a corresponding physical ID associated with the physical device, providing the virtual ID and physical ID to an update provider, and using the virtual ID and physical ID to determine which of a physical device driver and a corresponding virtual device driver corresponds to a driver update.

In still another aspect, a computer system includes a processor in a hypervisor-based computer system executing logic that includes distinguishing a physical device driver from a virtual device driver that is a counterpart to the physical device driver such that no confusion exists as between which of the drivers is an intended recipient of a driver update.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting system architecture; and

FIG. 2 is a flow chart of a non-limiting implementation of the update logic.

### DETAILED DESCRIPTION OF THE PREFERRED EMBODIMENT

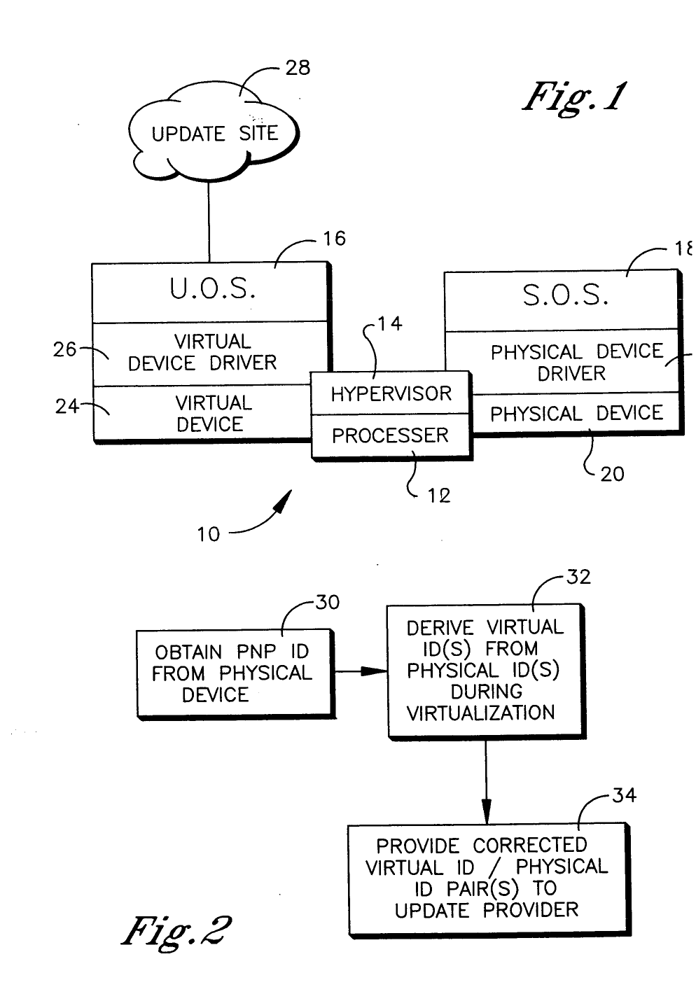

Referring initially to FIG. 1, a computer is shown, generally designated 10, which can be is not limited to being a personal computer, laptop computer, notebook computer. The computer 10 includes a processor 12 that executes a hypervisor 14, such as a type-1 hypervisor, to in turn, through the hypervisor 14, execute a user operating system (U.O.S.) 16 and a service operating system (S.O.S.) 18.

As shown in FIG. 1, the computer 10 can have one or more physical peripheral devices 20, such as printers, hard disk drives, video display monitors, etc. Each physical device is associated with a respective software-implemented physical device driver 22, with the hypervisor 14 permitting the S.O.S. 18 to manage the physical device(s) 20.

Additionally, in accordance with hypervisor virtualization principles known in the art, for each physical device 20 the hypervisor 14 creates a virtual device 24 that is a virtual replication of the physical device, with each virtual device 24 having an associated virtual device driver 26. The U.O.S. 16 operates through the hypervisor 14 on the virtual device driver 26 to access the virtual device 24. In accordance with principles discussed further below, updates to one or both of the virtual device driver 26 and physical device driver 22 can be obtained by the U.O.S. 16 from an update site 28 over, e.g., the Internet.

Now referring to FIG. 2, the overall logic can be seen. Commencing at block 30, the four-part plug-and-play (PNP) ID is obtained from the physical device 20. The associated physical device driver 22 contains a matching entry. As is known in the art, the PNP ID includes the following sub-IDs: a vendor ID, a device ID, a subsystem vendor ID, and a subsystem ID. The vendor and subsystem vendor IDs typically are assigned by the relevant peripheral computer interface (PCI) organization, whereas the device ID and subsystem device ID are versioning mechanisms that are typically assigned by the vendor or subvendor themselves. Updates to drivers are provided by the vendor or subvendor, or from the entity that provides OS updates.

Proceeding to block 32, one or more of these PnP sub-IDs are mapped from their original values to new values during instantiation of the virtual device 24 replication of the physical device 20 by the hypervisor 14. During mapping, the new [virtual] and old [physical] ID values are cross-correlated, so that updates have both of sets of values referenced to facilitate locating relevant updates. This is necessary to identify relevant updates, i.e., in the first embodiment the PnP IDs of both the physical and virtual devices 20, 24 are needed to properly identify devices to update. At block 34, the new PnP ID values are registered with the update providers, e.g., over the Internet. Consequently, to subsequently download a driver update, because the update utility possesses the cross-correlated virtual and physical PnP IDs, it can download the correct update to the correct driver, virtual or physical.

In a first embodiment, the update site 28 shown in FIG. 1, which possesses both the original driver with the “old” [physical] IDs as well as the “new” [virtual] IDs, can indicate to the client computer 10 that an update is available. The U.O.S. 16 temporarily shuts down the hypervisor 14, downloads and installs the update, and then restarts the hypervisor 14.

In this embodiment, the vendor ID of the actual physical device 20 in the downloaded update can be replaced with a vendor ID of the virtual device driver 26. Also, the device ID of the virtual instantiation 24 of the physical device 20 can be assigned by any appropriate method by the virtual device implementor. In contrast, the subsystem vendor ID and subsystem ID of the original PNP ID are carried forward from the actual hardware device 20, i.e., these latter two IDs do not change. Thus, the virtual device driver 26 contains a PNP entry for a virtual vendor ID and virtual device ID that are different than the corresponding IDs for the underlying physical device 20, whereas the subsystem vendor IDs and subsystem IDs are the same in the virtual device 24 as they are in the physical device 20.

Accordingly, the subsystem vendor ID and subsystem ID (i.e., the common IDs) are sufficient to determine the vendor ID and device ID. For example, a given network card (or other peripheral device) by convention would not be assigned the same subsystem IDs and be implemented using two different vendor IDs and device IDs.

In a second embodiment, rather than obtaining a new vendor ID, one or more bits of the device ID can be reserved for indicating (using a zero or a one) whether the given device is real or virtual. That is, a part or field of the device ID (at least one bit) can be used for indicating whether the given device is real or virtual. The same vendor ID, subsystem vendor ID, and subsystem ID reported by the physical device 20 are passed-through by the virtual device 24. The vendor ID can be modified by the virtual device driver 26 to set the designated virtual indicator bit or bits.

In yet a third embodiment, the S.O.S. 18 divulges the physical device's full four-part PNP ID to the U.O.S. 16 without modification. The driver update software executed by the computer 10 and/or update site 28 detects the nature of the device against which it is being installed, real or virtual, through, for example, querying hardware capabilities, and then installs the correct driver function accordingly. In this implementation, the physical PnP ID of the physical device 20 is carried directly through to the virtual device 24, with the driver update installation software determining the nature (physical or virtual) and location (U.O.S.- or S.O.S.-controlled) of the devices, and updating accordingly.

While the particular SYSTEM AND METHOD FOR DEVICE DRIVER UPDATES IN HYPERVISOR-OPERATED COMPUTER SYSTEM is herein shown and described in detail, it is to be understood that the subject matter encompassed by the present invention is limited only by the claims.

What is claimed is:

1. A method for updating at least one device driver in a computer implementing a hypervisor that instantiates a virtual device that is a replication of a physical device, comprising:
deriving at least one virtual ID from a corresponding physical ID associated with the physical device;
providing the virtual ID and physical ID to an update provider; and
using the virtual ID and physical ID to determine which of a physical device driver and a corresponding virtual device driver corresponds to a driver update.

2. The method of claim 1, wherein the physical and virtual IDs are physical and virtual plug-n-play (PnP) IDs, respectively, each having respective sub-IDs.

3. The method of claim 2, wherein one or more of the sub-IDs of the physical PnP ID are mapped from their original values to virtual sub-ID values during instantiation of the virtual device replication of the physical device.

4. The method of claim 1, comprising cross-correlating the virtual ID and physical ID.

5. The method of claim 2, wherein the virtual PnP ID has the same subsystem vendor ID and subsystem ID as the physical PnP ID, at least a vendor ID and/or a device ID of the virtual PnP ID being different than a respective vendor ID/device ID of the physical PnP ID.

6. The method of claim 2, wherein the physical PnP ID is the same as the virtual PnP ID with the exception of a value of at least one bit representing whether the associated device is physical or virtual.

7. The method of claim 6, wherein the bit is part of a device ID of the PnP IDs.

8. A computer system comprising:
a processor executing a hypervisor;
a service operating system (S.O.S.) operating on the hypervisor;
a user operating system (U.O.S.) operating on the hypervisor;
at least one physical device with associated physical device driver controlled by the S.O.S.;
at least one hypervisor-instantiated virtual device representing the physical device, the virtual device being associated with a virtual device driver and being controlled by the U.O.S.; and
means for downloading device driver updates that prevents confusion on the part of driver update software as to which driver, physical or virtual, is being updated.

9. The system of claim 8, wherein the means for downloading includes the processor executing logic comprising:
causing the S.O.S. to divulge to the U.O.S. a PnP ID associated with the physical device; and
detecting the nature of the device against which a driver update is being installed, real or virtual, and installing a driver update accordingly.

10. The system of claim 8, wherein the means for downloading includes the processor executing logic including:
deriving at least one virtual ID from a corresponding physical ID associated with the physical device;
providing the virtual ID and physical ID to an update provider; and
using the virtual ID and physical ID to determine which of a physical device driver and a corresponding virtual device driver corresponds to a driver update.

11. The system of claim 10, wherein the physical and virtual IDs are physical and virtual plug-n-play (PnP) IDs, respectively, each having respective sub-IDs.

12. The system of claim 11, wherein one or more of the sub-IDs of the physical PnP ID are mapped from their original values to virtual sub-ID values during instantiation of the virtual device replication of the physical device.

13. The system of claim 10, comprising cross-correlating the virtual ID and physical ID.

14. The system of claim 11, wherein the virtual PnP ID has the same subsystem vendor ID and subsystem ID as the physical PnP ID, at least a vendor ID and/or a device ID of the virtual PnP ID being different than a respective vendor ID/device ID of the physical PnP ID.

15. The system of claim 11, wherein the physical PnP ID is the same as the virtual PnP ID with the exception of a value of at least one bit representing whether the associated device is physical or virtual.

16. The system of claim 15, wherein the bit is part of a device ID of the PnP IDs.

17. A hypervisor-based computer system, comprising:
at least one processor executing logic in the hypervisor-based system, the logic comprising:
distinguishing a physical device driver from a virtual device driver that is a counterpart to the physical device driver such that no confusion exists as between which of the drivers is an intended recipient of a driver update.

18. The system of claim 17, wherein the logic executed by the processor to distinguish the drivers from each other includes:
causing a S.O.S. to divulge to a U.O.S. a PnP ID associated with a physical device with which the physical device driver is associated; and
detecting the nature of the device against which a driver update is being installed, real or virtual.

19. The system of claim 17, wherein the logic executed by the processor to distinguish the drivers from each other includes:
deriving at least one virtual ID from a corresponding physical ID associated with a physical device with which the physical device driver is associated;
providing the virtual ID and physical ID to an update provider; and
using the virtual ID and physical ID to determine which of a physical device driver and a corresponding virtual device driver corresponds to a driver update.

20. The system of claim 19, wherein one or more sub-IDs of the physical ID are mapped from their original values to virtual sub-ID values during instantiation of a virtual device replication of the physical device.

21. The system of claim 20, wherein the virtual ID has the same subsystem vendor ID and subsystem ID as the physical ID, at least a vendor ID and/or a device ID of the virtual ID being different than a respective vendor ID/device ID of the physical ID.

22. The system of claim 19, wherein the physical ID is the same as the virtual ID with the exception of a value of at least one bit representing whether the associated device is physical or virtual.
